(19) United States
(12) Patent Application Publication
(10) Pub. No.: US 2009/0155457 A1
(43) Pub. Date: Jun. 18, 2009

(54) DIE COATER AND METHOD FOR FABRICATING PLASMA-DISPLAY-PANEL SUBSTRATE ASSEMBLY

(76) Inventors: Daisuke IKEDA, Miyazaki (JP); Akira Shimoyoshi, Miyazaki (JP); Motonari Kifune, Miyazaki (JP); Hideaki Hirabara, Miyazaki (JP)

Correspondence Address: MCDERMOTT WILL & EMERY LLP, 600 13TH STREET, N.W., WASHINGTON, DC, 20005-3096, US

(21) Appl. No.: 12/196,674

(22) Filed: Aug. 22, 2008

(30) Foreign Application Priority Data
Dec. 13, 2007 (JP) 2007-322273

(51) Int. Cl. B05D 5/06; B05C 5/02

(52) U.S. Cl. 427/64; 118/300

(57) ABSTRACT

A die coater of the present invention includes: a replaceable-type paste container containing a paste inside thereof and including, in its upper surface, a paste ejection port for ejecting the paste; a buffer tank for storing the paste ejected from the paste ejection port; and a coat-layer formation portion for discharging the paste ejected from the buffer tank onto a substrate through a head to form a coat layer, wherein the paste container is placed such that the upper surface thereof is oriented more downwardly than a vertical plane, in order to cause the paste to be ejected from the paste ejection port due to its weight.

### CROSS-REFERENCE TO RELATED APPLICATION

This application is related to Japanese Patent Application No. 2007-322273 filed on Dec. 13, 2007, whose priority is claimed and the disclosure of which is incorporated by reference in its entirety.

### BACKGROUND OF THE INVENTION

1. Field of the Invention

The present invention relates to a die coater and a method for fabricating a substrate assembly for a plasma display panel (hereinafter, referred to as a “PDP”) using the same.

2. Description of the Related Art

FIG. 10 is an exploded perspective view illustrating an exemplary structure of a conventional AC-driven surface-discharge PDP. The PDP has a front-side substrate assembly 1 and a rear-side substrate assembly 2.

The front-side substrate assembly 1 includes plural display electrodes 3 placed on a glass substrate 1a. The display electrodes 3 are each constituted by a transparent electrode 3a and a bus electrode 3b and are covered with a dielectric layer for AC driving. The dielectric layer 4 is covered with a protective layer 5.

The rear-side substrate assembly 2 includes address electrodes 6 extending in the direction orthogonal to the display electrodes 3 (in the row direction), the address electrodes 6 being placed on a glass substrate 2a. The address electrodes 6 are covered with a dielectric layer 9. On the dielectric layer 9, plural barrier ribs 7 are placed such that they sandwich the address electrodes 6, so that the barrier ribs separate cells in the row direction from one another. Further, on the surface of the dielectric layer 9 and on the side surfaces of the barrier ribs 7, there is formed a fluorescent layer 8 which generates visible light of red (R), green (G) and blue (B) by being excited by a UV ray. Also, the address electrodes 6 may be placed in the dielectric layer 4 in the front-side substrate assembly 1 such that they intersect with the display electrodes 3.

At a state where the front-side substrate assembly 1 and the rear-side substrate assembly 2 are faced to each other such that the protective layer 5 contacts with the barrier ribs 7, their peripheral portions are attached to each other in a sealing manner through a sealing member to form plural electric-discharge spaces separated from one another by the barrier ribs. Air is exhausted from the electric-discharge spaces and, thereafter, an electric-discharge gas such as Ne-Xe is enclosed in the electric-discharge spaces to complete the fabrication of the PDP. Displaying with this PDP is performed by repeatedly performing electric discharge between each two adjacent display electrodes 3.

In an example, the dielectric layers 4 and 9 are formed by applying a low-melting-point glass paste to the surface of a glass substrate on which electrodes should be formed to form a coat layer, using a table-type die coater, and then firing this coat layer.

Hereinafter, a conventional die coater will be described with reference to FIG. 11. FIG. 11 is a structural view of the conventional die coater.

As illustrated in FIG. 11, the die coater includes a coating stage 11 for placing a substrate 13 thereon, a paste container (for example, a drum can) 23 containing a paste, a head 17 for discharging the paste 19 onto the substrate 13 for forming a coat layer 20, and pumps (a mohno pump 29 and a syringe pump 33) for sucking up the paste 19 within the paste container 23 and transferring it to the head 17.

The paste container 23 is of a replaceable type. Accordingly, when the amount of the paste 19 in the paste container 23 has been decreased, the processing is temporarily interrupted, the paste container 23 is removed, then another paste container 23 containing a sufficient amount of a paste 19 is mounted, and the processing is restarted.

The paste container 23 containing the sufficient amount of the paste 19 may have a weight greater than 200 kg and cannot be easily lifted. Therefore, in general, the paste container 23 is placed on a floor 10.

Further, such a die coater is disclosed in Japanese Unexamined Patent Publication No. 2006-134873 and in 1998 FPD Technology Outlook in pages 424 to 427 (electronic journal).

With the die coater having the aforementioned structure, even when the amount of the remaining paste 19 within the paste container 23 is about 15%, a sufficient amount of the paste 19 cannot be supplied to the head 17, thereby preventing the formation of an appropriate coat layer 20. This degrades the efficiency of usage of the paste 19. Further, with the die coater having the aforementioned structure, it is required to temporarily interrupt the processing at the time of the replacement of the paste container 23, thus the productivity is not high.

### SUMMARY OF THE INVENTION

It is an object of the present invention to provide a die coater capable of increasing the efficiency of usage of a paste within a paste container and also capable of eliminating the necessity of interrupting processing at the time of replacement of the paste container.

A die coater according to the present invention includes: a replaceable-type paste container containing a paste inside thereof and including, in its upper surface, a paste ejection port for ejecting the paste; a buffer tank for storing the paste ejected from the paste ejection port; and a coat-layer formation portion for discharging the paste ejected from the buffer tank onto a substrate through a head to form a coat layer, wherein the paste container is placed such that the upper surface thereof is oriented more downwardly than a vertical plane, in order to cause the paste to be ejected from the paste ejection port due to its weight.

With the present invention, the paste is ejected from the paste container due to its weight, which causes the paste to be easily extracted until the paste container becomes substantially empty. Accordingly, with the present invention, it is possible to increase the efficiency of usage of the paste. Further, with the present invention, there is provided the buffer tank for storing the paste from the paste container, which enables continuing the processing using the paste within the buffer tank during the replacement of the paste container. Accordingly, with the present invention, it is possible to eliminate the necessity of interrupting the processing at the time of the replacement of the paste container.

### BRIEF DESCRIPTION OF THE DRAWINGS

FIG. 1 is a structural view of a die coater according to a first example of the present invention;

FIG. 2 illustrates a paste container in the die coater according to the first example of the present invention, wherein FIG. 2A is a plan view, FIG. 2B is a cross-sectional view taken along the line I-I in FIG. 2A, and FIG. 2C is a perspective view;

FIG. 3 is a plan view of an arm portion and a holding portion in a paste-container holding device in the die coater according to the first example of the present invention, wherein FIG. 3A illustrates a state before the paste container is secured to the holding portion, and FIG. 3B illustrates a state where the paste container has been secured to the holding portion;

FIGS. 4A to E are views for describing a method for replacing the paste container in the die coater according to the first example of the present invention;

FIG. 5 is a structural view of a die coater according to a second example of the present invention;

FIG. 6 is a structural view of a die coater according to a third example of the present invention;

FIGS. 7A to D are cross-sectional views illustrating a PDP substrate assembly to which the present invention is applied;

FIG. 8 is a graph illustrating the relationship between the amount of the remaining paste within the paste container and the height of the liquid level of the paste within the buffer tank (the paste viscosity of 8700 cps), which were resulted from experiments for demonstrations of effects of the present invention;

FIG. 9 is a graph illustrating the relationship between the amount of the remaining paste within the paste container and the height of the liquid level of the paste within the buffer tank (the paste viscosity of 14000 cps), which were resulted from experiments for demonstrations of effects of the present invention;

FIG. 10 is an exploded perspective view illustrating a conventional PDP structure; and

FIG. 11 is a structural view of a conventional die coater.

### DESCRIPTION OF THE PREFERRED EMBODIMENTS

Hereinafter, various types of embodiments and the like of the present invention will be exemplified.

The paste container can further include an air intake port in its upper surface and can include a pipe inserted through the air intake port and extended up to the vicinity of the lower surface of the paste container.

The paste container can be held by a paste-container holding device capable of rotating and securing the paste container.

The paste container can be placed at a state where the upper surface thereof is inclined by 120 to 150 degrees or by 210 to 240 degrees with respect to a horizontal state.

The buffer tank can include a paste inlet/outlet portion for introducing/ejecting the paste, the paste inlet/outlet port can be provided at a position at which the paste is ejected therefrom due to its weight, and the paste inlet/outlet port can be placed at a position lower than the paste ejection port.

The buffer tank can include a paste inlet for causing the paste to flow therein and a paste outlet for ejecting the paste, wherein the paste outlet can be provided at a position at which the paste is ejected therefrom due to its weight, and the paste inlet can be placed at a position lower than the paste ejection port of the paste container.

The paste can have a viscosity in the range of 1000 to 10000 cps.

The coat-layer formation portion can include a mohno pump and a syringe pump in this order between the buffer tank and the head.

With the present invention, there is provided a method for fabricating a plasma-display-panel substrate assembly including the steps of: applying a low-melting-point glass paste to a substrate having electrodes formed thereon using the die coater described above to form a coat layer; and firing the coat layer to form a dielectric layer.

The various types of embodiments described above can be combined with one another.

Hereinafter, preferred examples of the present invention will be described with reference to the drawings, but the scope of the present invention is not limited to the drawings and the contents of the following description.

### 1. DIE COATER

### 1-1. FIRST EXAMPLE

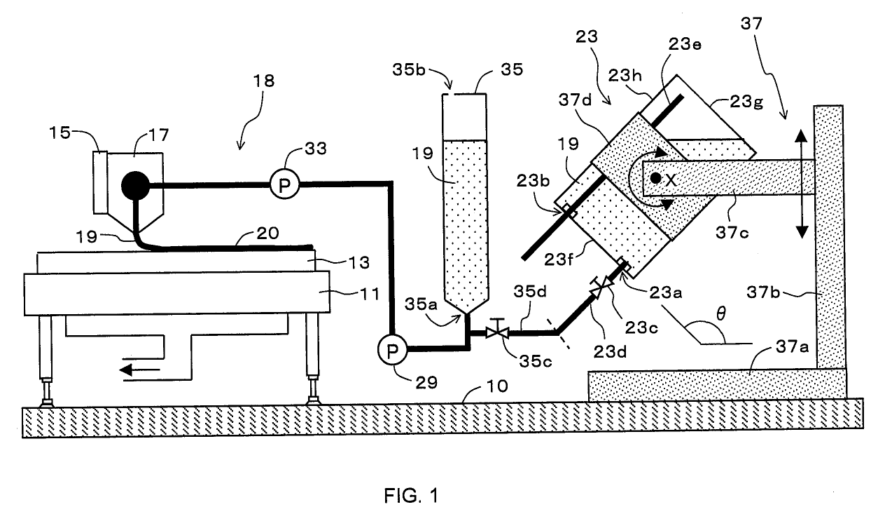

With reference to FIG. 1, a die coater according to a first example of the present invention will be described. FIG. 1 is a view of the structure of the die coater according to the present example.

The die coater according to the first example includes a replaceable-type paste container 23 containing a paste 19 inside thereof and including a paste ejection port 23a for ejecting the paste 19 in its upper surface 23f, a buffer tank 35 for storing the paste 19 ejected from the paste ejection port 23a, and a coat-layer formation portion 18 for discharging the paste 19 ejected from the buffer tank 35 onto a substrate 13 through a head 17 to form a coat layer 20. The paste container 23 is placed such that its upper surface 23f is oriented more downwardly than a vertical plane, in order to cause the paste 19 to be ejected through the paste ejection port 23a due to its weight.

Hereinafter, the respective components will be described.

### 1-1-1. PASTE CONTAINER

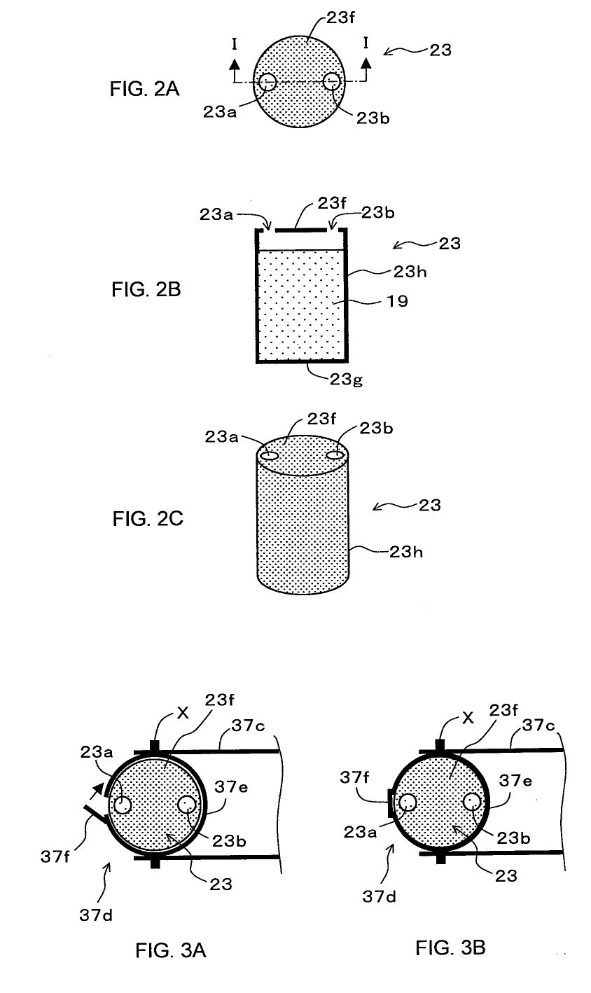

With reference to FIGS. 2A to 2C, the paste container 23 will be described. FIG. 2A is a plan view, FIG. 2B is a cross-sectional view taken along the line I-I in FIG. 2A, and FIG. 2C is a perspective view.

The paste container 23 is a container for containing the paste 19, and the shape and the material thereof are not particularly limited, but an example thereof is a cylindrical container and, more specifically, is a metal cylindrical container, such as a drum can

The paste container 23 is of a replaceable type. Accordingly, when the amount of the paste 19 within the paste container 23 has been decreased, the paste container 23 is detached and, thereafter, another paste container 23 containing a large amount of a paste 19 is attached to replenish the paste 19. The paste container 23 according to the first example is essentially different from a fixed-type paste tank adapted such that the paste is replenished while it is attached to a die coater.

The paste container 23 includes, in its upper surface 23f, the paste ejection port 23a for ejecting the paste 19 and an air intake port 23b for introducing air.

The positions of the paste ejection port 23a and the air intake port 23b in the upper surface 23f of the paste container 23 are not particularly limited, but it is preferable that the paste ejection port 23a and the air intake port 23b are positioned in the opposite sides across the center of the upper surface 23f. It is preferable that the paste ejection port 23a and the air intake port 23b are respectively positioned at ends of the upper surface 23f. This is because this placement facilitates the ejection of the paste due to its weight. A pipe 23d having a valve 23c is mounted to the paste ejection port 23a. The valve 23c is usually opened, but is closed at the time of replacement of the paste container 23. A pipe 23e extending up to the vicinity of the lower surface 23g of the paste container 23 is inserted through the air intake port 23b. Air is introduced into the paste container 23 through the pipe 23e, thereby facilitating the ejection of the paste 19. Further, the air intake port 23b and the pipe 23e are not necessarily required, and holes can be formed through the lower surface 23g and the side surface 23h of the paste container 23 for introducing air into the paste container 23.

The paste container 23 is placed, such that its upper surface 23f is oriented more downwardly than a vertical plane, in order to cause the paste 19 to be ejected due to its weight through the paste ejection port 23a. In other words, the paste container 23 is placed, such that the angle θ of the inclination of the upper surface 23f of the paste container 23 with respect to the horizontal state (the state where it is placed as illustrated in FIG. 2C) is greater than 90 degrees, but is smaller than 270 degrees. The inclination angle θ is preferably in the range of 120 to 150 degrees or in the range of 210 to 240 degrees and, more preferably, in the range of 130 to 140 degrees or in the range of 220 to 230 degrees. This is because, in this case, both the paste 19 adhered to the upper surface 23f of the paste container 23 and the paste 19 adhered to the side surface 23h tend to gather at an end of the upper surface 23f of the paste container 23. Further, preferably, the paste container 23 is placed such that the paste ejection port 23a is at a position lower than the air intake port 23b and, in the case of FIG. 1, the inclination angle θ is preferably in the range of 120 to 150 degrees and, more preferably, in the range of 130 to 140 degrees. In the case where the positions of the paste ejection port 23a and the air intake port 23b are interchanged, the inclination angle θ is preferably in the range of 210 to 240 degrees and, more preferably, in the range of 220 to 230 degrees.

The paste container 23 is held by a paste-container holding device 37 capable of rotating and fixing the paste container 23. The paste-container holding device 37 is placed on a floor 10. The paste-container holding device 37 can be adapted to be operated either electrically or manually. The structure of the paste-container holding device 37 is not particularly limited, but an example of the paste-container holding device 37 includes a base portion 37a, a column portion 37b extending upwardly from the base portion 37a, an arm portion 37c movable upwardly and downwardly with respect to the column portion 37b, and a holding portion 37d being rotatable with respect to the arm portion 37c and being capable of holding the paste container 23. The holding portion 37d is rotatable about an axis X.

The structure of the holding portion 37d is not particularly limited, but an example of the holding portion 37d includes a holding-portion main body 37e and a lever portion 37f, as illustrated in FIG. 3A. The holding-portion main body 37e is shaped to surround the outer shape of the paste container 23. By installing the paste container 23 within the holding-portion main body 37e and moving the lever portion 37f in the direction of an arrow, at this state, to secure the lever portion 37f to the holding-portion main body 37e, it is possible to hold the paste container 23 in the holding portion 37d, as illustrated in FIG. 3B.

The viscosity of the paste 19 contained in the paste container 23 is not particularly limited, but it is, for example, in the range of 1000 to 10000 cps and, more specifically, for example, 1000, 2000, 3000, 4000, 5000, 6000, 7000, 8000, 9000 or 10000. The viscosity of the paste 19 can be in the range between any two of these exemplified numerical values. When the viscosity of the paste 19 is equal to or less than 10000 cps, it is easy to eject the paste 19 through its weight. Further, when the viscosity of the paste 19 is equal to or more than 1000 cps, it is easy to form a coat layer 20. In the present invention, “the viscosity” means the value of the viscosity when the shear rate is 0.1 rps.

The type of the paste 19 is not particularly limited, but, in the case of forming the dielectric layer in the aforementioned PDP, the paste 19 is a low-melting-point glass paste formed by adding a binder and a solvent to a low-melting-point glass frit.

### 1-1-2. BUFFER TANK

The buffer tank 35 is a tank for storing the paste 19 ejected from the paste ejection port 23a of the paste container 23, and the shape and the material thereof are not particularly limited.

When the paste 19 is used for forming a coat layer 20, the amount of the paste 19 within the buffer tank 35 is decreased. When the amount of the paste 19 within the buffer tank 35 has been decreased, the paste 19 is replenished from the paste container 23. This replenishment is attained by the weight of the paste 19, which causes the liquid level of the paste 19 within the buffer tank 35 to be substantially coincident with the liquid level of the paste 19 within the paste container 23 (usually, they are not completely coincident with each other due to the viscosity of the paste 19, pressure losses therein, and the like).

The buffer tank 35 includes a paste inlet/outlet port 35a for introducing and ejecting the paste 19, and an air intake port 35b for introducing air. The paste inlet/outlet port 35a is provided at a position at which the paste 19 is ejected from the buffer tank 35 due to its weight. Further, the paste inlet/outlet port 35a is placed at a position lower than the paste ejection port 23a of the paste container 23. Accordingly, the paste 19 within the paste container 23 smoothly flows into the buffer tank 35 due to its weight and, further, the paste 19 is smoothly ejected from the buffer tank 35 due to its weight.

The air intake port 35b is provided at a position higher than the maximum height of the liquid level of the paste 19. Since the air intake port 35b is provided, air is introduced into the paste container 23 through the air intake port 35b, thereby facilitating the ejection of the paste 19.

The paste inlet/outlet port 35a is provided with a pipe 35d communicated with the pipe 23d. The pipe 35d is provided with a valve 35c. The valve 35c is usually opened, but is closed at the time of replacement of the paste container 23.

No pump is provided between the paste container 23 and the buffer tank 35, and the paste container 23 and the buffer tank 35 are directly communicated with each other, so that the flow of the paste 19 is controlled by opening and closing the valve 23c and the valve 35c.

### 1-1-3. COAT-LAYER FORMATION PORTION

The coat-layer formation portion 18 discharges the paste 19 ejected from the buffer tank 35 onto the substrate 13 through the head 17 to form a coat layer 20. Further, in the structure of FIG. 1, in a normal state, the pastes 19 ejected from both the buffer tank 35 and the paste container 23 are supplied to the head 17 and, during the replacement of the paste container 23, the paste 19 ejected from the buffer tank 35 is supplied to the head 17. Accordingly, at any time, the paste 19 ejected from the buffer tank 35 is supplied to the head 17.

The coat-layer formation portion 18 includes the head 17 for discharging the paste 19, a driving portion (not illustrated) for moving the head 17, and a pump for transferring the paste 19 from the buffer tank 35 to the head 17. The head 17 discharges the paste 19 onto the substrate 13 through a nozzle provided at its tip end. The driving portion is capable of moving the head 17 in the direction of formation of a coat layer 20 or in the direction opposite therefrom.

An example of the pump is constituted by a mohno pump 29 and a syringe pump 33 which are provided in the mentioned order in the direction away from the buffer tank 35. A gap sensor 15 for determining the distance between the head 17 and the substrate 13 is mounted to the head 17.

The type of the substrate 13 is not particularly limited, but, in the case of the aforementioned PDP, it is a glass substrate having electrodes formed thereon, for example. The substrate 13 is installed on a coating stage 11. The coating stage 11 is made of a material which is less prone to deformation, such as a stone, cast iron, ceramic or the like. The coating stage 11 is placed on the floor 10. In the coating stage 11, there are formed a plurality of suction holes which are communicated with a vacuum pump. The substrate 13 is secured to and installed on the coating stage 11, by being sucked in a vacuum manner by the suction holes. However, the method for securing the substrate 13 is not particularly limited and, for example, the substrate 13 can be secured to the coating stage 11 by pressing the substrate 13 to the coating stage 11 from above the substrate 13, using a clamp or the like.

### 1-1-4. METHOD FOR REPLACEMENT OF THE PASTE CONTAINER

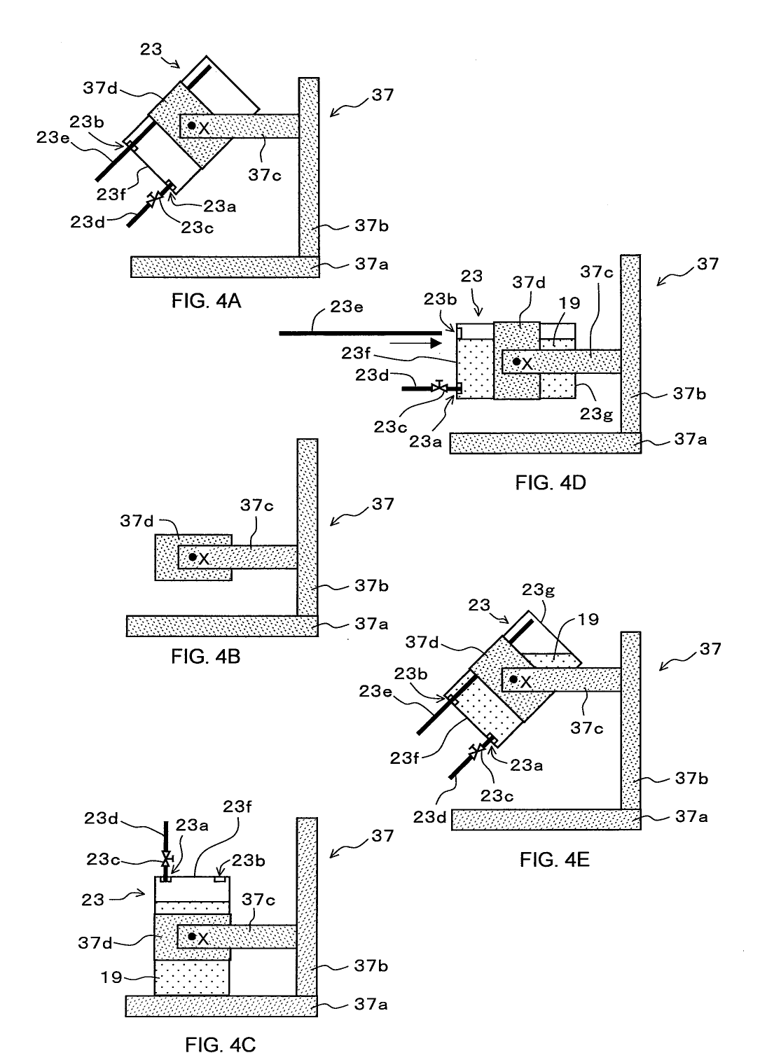

Hereinafter, a method for replacing the paste container 23 will be described, with reference to FIGS. 4A to 4E. The method which will be described hereinafter is merely an example, and the replacement can be performed according to different procedures.

When the paste container 23 contains the paste 19, the liquid level of the paste 19 within the buffer tank 35 is at a position higher than the paste ejection port 23a of the paste container 23, but, when the paste container 23 is empty, the liquid level of the paste 19 within the buffer tank 35 is at a position lower than the paste ejection port 23a of the paste container 23. Accordingly, by detecting that the liquid level of the paste 19 within the buffer tank 35 has been lowered to below a predetermined height, it is possible to detect that the paste container 23 has become empty. The liquid level of the paste 19 within the buffer tank 35 can be determined using a liquid-level sensor.

If it is detected that the paste container 23 has become empty, the valve 23c and the valve 35c are closed, thereby separating the pipe 23d and the pipe 35d from each other. FIG. 4A illustrates the state after they are separated from each other.

Next, the holding portion 37d is rotated such that the upper surface of the paste container 23 becomes horizontal and, thereafter, the paste container 23 is removed from the paste-container holding device 37 to realize a state illustrated in FIG. 4B.

Next, the pipe 23d having the valve 23c is mounted to another paste container 23 which contains a sufficient amount of a paste 19 and, thereafter, the paste container 23 is mounted to the holding portion 37d to realize a state illustrated in FIG. 4C. The pipe 23d having the valve 23c can be mounted to the paste container 23, after the paste container 23 is mounted to the holding portion 37d. A lid (not illustrated) is mounted to the air intake port 23b of the paste container 23.

Next, as illustrated in FIG. 4D, the holding portion 37d is rotated by 90 degrees about the axis X to realize a state where the upper surface 23f of the paste container 23 is inclined by 90 degrees with respect to the horizontal state. In the present example, the paste container 23 is rotated in the counter-clockwise direction, but the direction of the rotation of the paste container 23 is not particularly limited.

Next, the lid of the air intake port 23b is removed, the pipe 23e is inserted through the air intake port 23b, the pipe 23e is placed such that the tip end of the pipe 23e is positioned near the lower surface 23g of the paste container 23, and the pipe 23e is secured to the paste container 23. By inserting the pipe 23e therethrough at the state where the upper surface 23f of the paste container 23 is inclined by 90 degrees with respect to the horizontal state, it is possible to prevent the paste 19 from intruding into the pipe 23e to cause clogging of the pipe 23e.

Next, as illustrated in FIG. 4E, the holding portion 37d is further rotated about the axis X, thereby rotating the paste container 23, such that the upper surface 23f of the paste container 23 is oriented more downwardly than a vertical plane.

Next, the pipe 23d in the paste container 23 and the pipe 35d in the buffer tank 35 are communicated with each other, and the valve 23c and the valve 35c are opened. Thus, the supply of the paste 19 from the paste container 23 to the buffer tank 35 is restarted.

During the replacement of the paste container 23, the paste 19 is not supplied from the paste container 23 to the buffer tank 35. However, even during this, the processing can be continued using the paste 19 within the buffer tank 35. Accordingly, in the present example, it is not required to interrupt the processing at the time of the replacement of the paste container 23.

### 1-2. SECOND EXAMPLE

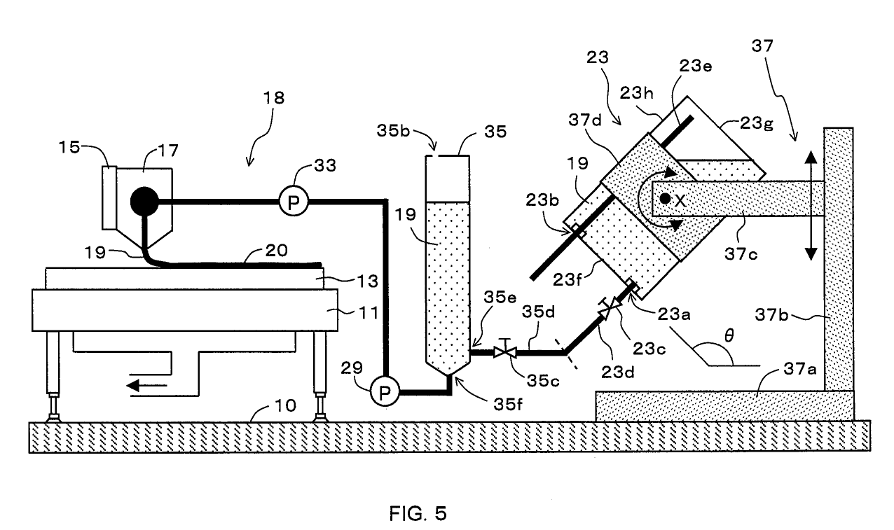

With reference to FIG. 5, a die coater according to the second example will be described. FIG. 5 is a structural view of the die coater according to the present example.

The second example is similar to the first example, and the contents described in the first example apply to the present second example, unless inconsistent with the following description.

In the die coater according to the second example, the buffer tank 35 includes a paste inlet 35e for causing the paste 19 to flow therein, and a paste outlet 35f for ejecting the paste 19. In the second example, since the buffer tank 35 includes the paste inlet 35e and the paste outlet 35f, there is the advantage that the paste is prevented from flowing back to the paste container from the buffer tank, when the paste within the buffer tank is transferred to the syringe pump through the mohno pump.

The paste outlet 35f is provided at a position at which the paste 19 is ejected due to its weight, while the paste inlet 35e is placed at a position lower than the paste ejection port 23a of the paste container 23. Accordingly, the paste 19 smoothly flows into the buffer tank 35 due to its weight and, further, the paste 19 is smoothly ejected from the buffer tank 35 due to its weight.

### 1-3. THIRD EXAMPLE

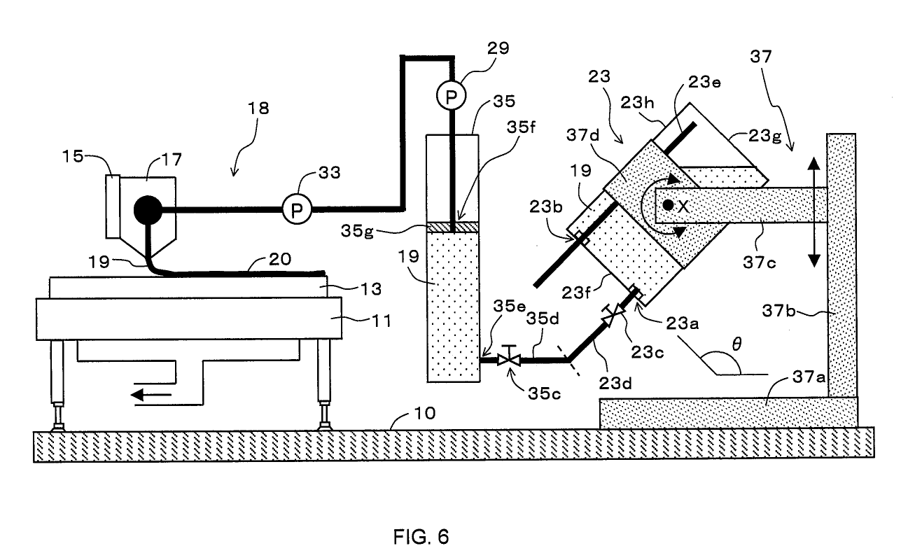

With reference to FIG. 6, a die coater according to the third example will be described. FIG. 6 is a structural view of the die coater according to the third example.

The third example is similar to the second example, and the contents described in the second example apply to the present third example, unless inconsistent with the following description.

In the die coater according to the third example, the paste outlet 35f for ejecting the paste 19 is provided at an upper portion of the buffer tank 35, so that the paste 19 cannot be ejected from the buffer tank 35 through its weight. The buffer tank 35 has a lid 35g on the paste 19. If the lid 35g is pushed downwardly and, concurrently, the paste 19 is sucked up through the mohno pump 29, the paste 19 is ejected from the buffer tank 35.

In the die coater according to the third example, the paste 19 is supplied to the buffer tank 35 from the paste container 23 due to its weight, but the paste 19 is not ejected from the buffer tank 35 due to its weight. However, the die coater according to the third example offers the advantage of increasing the efficiency of usage of the paste 19 within the paste container 23 and, further, offers the advantage of enabling replacement of the paste container 23 without interrupting the processing, as in the first and second examples.

The various characteristics described in the aforementioned examples can be combined with one another. In cases where a single example includes plural characteristics, one or more characteristics, out of them, can be properly extracted and can be employed solely or in combination with one another in the present invention.

### 2. METHOD FOR FABRICATING A PDP SUBSTRATE ASSEMBLY

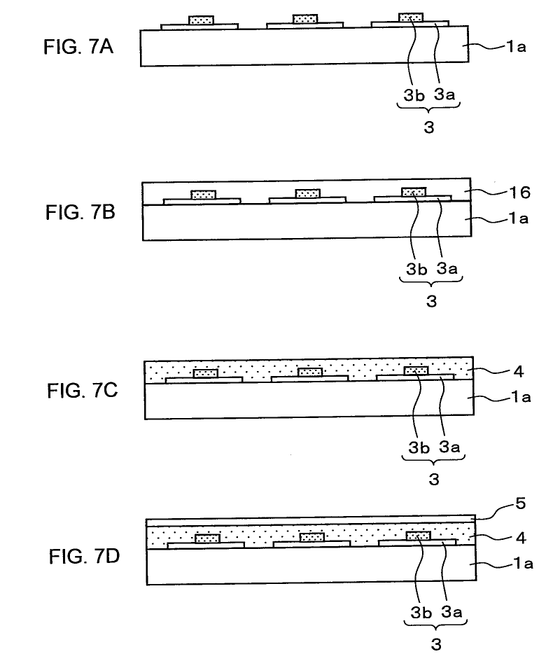

With reference to FIGS. 7A to 7D, there will be described a method for fabricating a PDP substrate assembly to which the present invention is applied. FIGS. 7A to 7D are cross-sectional views illustrating processes for fabricating a PDP substrate assembly according to the present example. In the following example, description will be given by exemplifying a case of fabricating a 3-electrode surface-discharge type PDP front-side substrate assembly.

### 2-1. PROCESSING FOR FORMING DISPLAY ELECTRODES

At first, as illustrated in FIG. 7A, plural display electrodes 3 are formed on a substrate 1a.

The substrate 1a is not particularly limited and can be any substrate known in this field. More specifically, it can be a transparent substrate, such as a glass substrate or a plastic substrate.

The plural display electrodes 3 each include a transparent electrode 3a and a metal electrode 3b. The transparent electrode 3a can be formed by forming a transparent electrode material film made of ITO, SnO₂ or the like through sputtering or the like and, then, patterning the transparent electrode material film into the shape of the transparent electrode 3a. The metal electrode 3b can be formed by forming a metal film or a laminated-layer film which is made of, for example, Ag, Au, Al, Cu or Cr or a laminated-layer member made of these metals (for example, a laminated-layer structure made of Cr-Cu-Cr), through sputtering or the like, and then patterning the film into the shape of the metal electrode 3b. The aforementioned patterning can be performed by a photo-etching method. In an example, the transparent electrode 3a and the metal electrode 3b have thicknesses of 0.1 micrometer and 3.5 micrometers, respectively.

Out of the plural display electrodes 3, each two display electrodes 3 pair up with each other and constitute a display line. In an aspect of an electrode arrangement, they are placed in an arrangement in which a non-discharge area (also referred to as a reverse slit) is provided between each pair of electrodes or in an ALIS-type arrangement in which the electrodes are arranged at even intervals and the gaps between adjacent electrodes all form discharge areas.

### 2-2. PROCESSING FOR FORMING A DIELECTRIC LAYER (FORMING A COAT-LAYER AND FIRING

Next, as illustrated in FIG. 7B, a low-melting-point glass paste is applied to the substrate 1a on which the display electrodes 3 have been formed to form a coat layer 16 and, as illustrated in FIG. 7C, the coat layer 16 is fired to form a dielectric layer 4. The low-melting-point glass paste is made of a low-melting-point glass frit containing a binder and a solvent mixed therein. The coat layer 16 can be formed using the die coater according to the aforementioned examples.

### 2-3. PROCESSING FOR FORMING A PROTECTIVE LAYER

Next, as illustrated in FIG. 7D, a protective layer 5 is formed on the dielectric layer 4 to complete the fabrication of the front-side substrate assembly. The protective layer 5 is made of an oxide of a metal (more specifically, a divalent metal), such as a magnesium oxide, a strontium oxide or a barium oxide and, preferably, is made of a magnesium oxide. The protective layer 5 can be formed by sputtering or coating or the like. In an example, the protective layer 5 has a thickness of about 8000 angstroms.

Here, the front-side substrate assembly fabricated as described above is attached to a separately-fabricated rear-side substrate assembly on which address electrodes, a dielectric layer, barrier ribs and a fluorescent layer have been formed to form a panel having an airtight electric-discharge space inside thereof. Air is exhausted from the electric-discharge space in this panel and, thereafter, an electric-discharge gas formed from neon, xenon and the like is introduced into the electric-discharge space to complete the fabrication of a PDP.

While, in this case, the die coater according to the aforementioned examples is used for forming the dielectric layer covering the display electrodes 3 in the PDP front-side substrate assembly, the die coater according to the aforementioned examples can be also used for forming the dielectric layer covering the address electrodes on the PDP rear-side substrate assembly or the barrier rib material layer for forming the barrier ribs and, also, can be used for other applications than fabrication of a PDP.

### 3. EXPERIMENTS FOR DEMONSTRATIONS OF EFFECTS

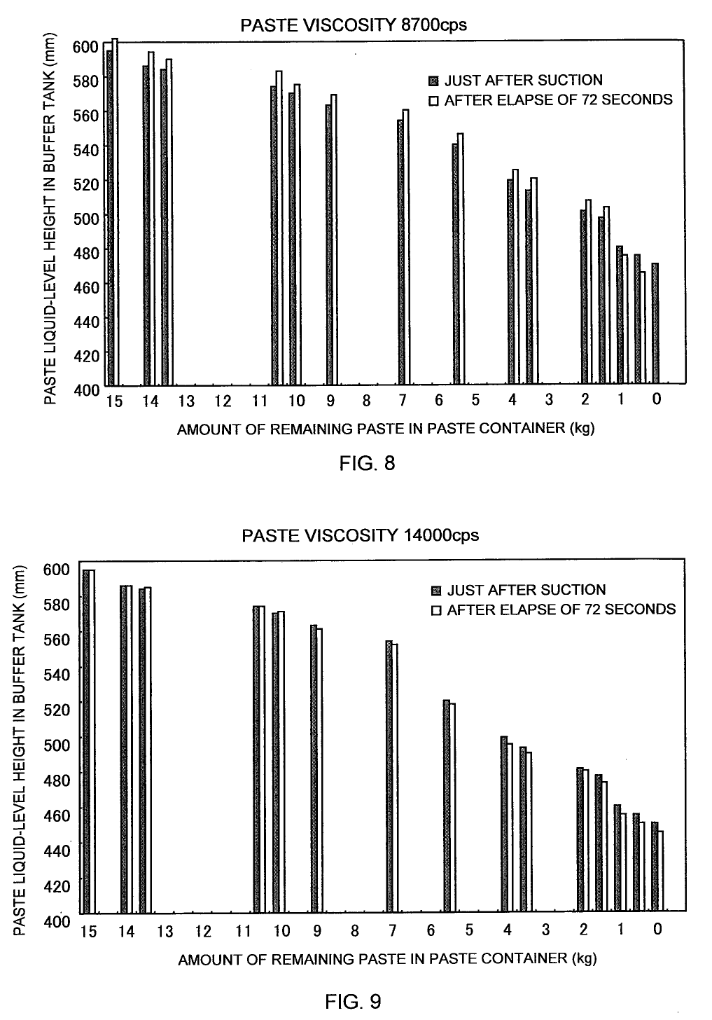

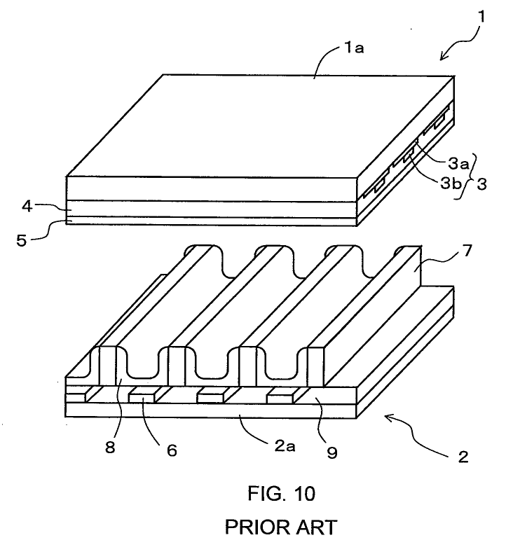

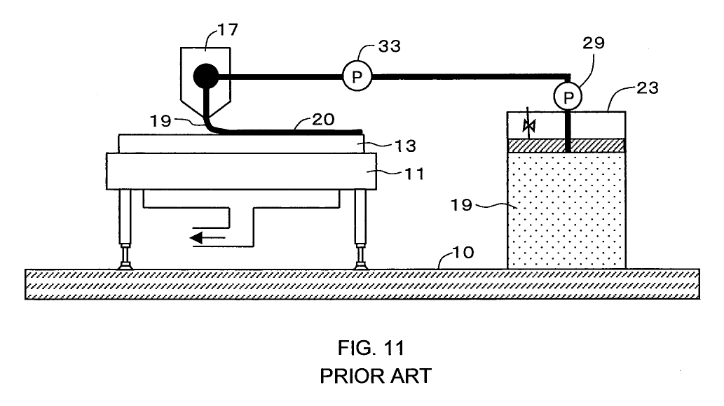

Investigations were conducted for determining how the height of the liquid level of the paste within the buffer tank 35 was changed depending on the remaining amount of the paste within the paste container 23, with respect to the die coater according to the first example. FIG. 8 and FIG. 9 illustrate the results. FIG. 8 illustrates the results of the case where the paste 19 had a viscosity of 8700 cps, while FIG. 9 illustrates the results of the case where the paste 19 had a viscosity of 14000 cps. In FIG. 8 and FIG. 9, the terms “just after suction” mean the height of the liquid level of the paste within the buffer tank 35 just after suction of the paste 19 through the syringe pump 33, and the terms “after the elapse of 72 seconds” mean the height of the liquid level of the paste after the elapse of 72 seconds since “just after suction”.

Referring to FIG. 8 and FIG. 9, it can be seen that, in both the cases where the paste 19 had a viscosity of 8700 cps and 14000 cps, when the amount of the remaining paste within the paste container 23 became 0, the height of the liquid level of the paste within the buffer tank 35 was equal to or higher than 400 mm. These results reveal that the paste 19 within the paste container 23 was properly supplied to the buffer tank 35 until the paste container 23 became empty, thereby demonstrating that the efficiency of usage of the paste 19 within the paste container 23 can be increased with the present invention.

Further, referring to FIG. 8 and FIG. 9, it can be seen that, in FIG. 8, the paste liquid level was raised after the elapse of 72 seconds since it was lowered by the suction, while, in FIG. 9, the paste liquid level was hardly changed after the elapse of 72 seconds. This indicates that, in the case of FIG. 8, the paste 19 was supplied to the buffer tank 35 from the paste container 23 more smoothly. These results indicate that the paste viscosity is preferably equal to or lower than 10000 cps.

What is claimed is:

1. A die coater for forming a layer of a paste, comprising:
a replaceable-type paste container containing the paste inside thereof and including, in its upper surface, a paste ejection port for ejecting the paste;
a buffer tank for storing the paste ejected from the paste ejection port; and
a coat-layer formation portion for discharging the paste ejected from the buffer tank onto a substrate through a head to form a coat layer, wherein
the paste container is placed such that the upper surface thereof is oriented more downwardly than a vertical plane, in order to cause the paste to be ejected from the paste ejection port due to its weight.

2. The die coater of claim 1, wherein the paste container further includes an air intake port in its upper surface, and a pipe inserted through the air intake port and extended up to the vicinity of the lower surface of the paste container.

3. The die coater of claim 1, wherein the paste container is held by a paste-container holding device capable of rotating and securing the paste container.

4. The die coater of claim 1, wherein the paste container is placed at a state where the upper surface thereof is inclined by 120 to 150 degrees or by 210 to 240 degrees with respect to a horizontal state.

5. The die coater of claim 3, wherein the paste container is placed at a state where the upper surface thereof is inclined by 120 to 150 degrees or by 210 to 240 degrees with respect to a horizontal state.

6. The die coater of claim 1, wherein the buffer tank includes a paste inlet/outlet portion for introducing/ejecting the paste, the paste inlet/outlet port is provided at a position at which the paste is ejected therefrom due to its weight, and the paste inlet/outlet port is placed at a position lower than the paste ejection port.

7. The die coater of claim 1, wherein the buffer tank includes a paste inlet for causing the paste to flow therein and a paste outlet for ejecting the paste, the paste outlet is provided at a position at which the paste is ejected therefrom due to its weight, and the paste inlet is placed at a position lower than the paste ejection port of the paste container.

8. The die coater of claim 1, wherein the paste has a viscosity in the range of 1000 to 10000 cps.

9. The die coater of claim 1, wherein the coat-layer formation portion includes a mohno pump and a syringe pump, between the buffer tank and the head, in this order from the buffer tank.

10. A method for fabricating a plasma-display-panel substrate assembly including the steps of: applying a low-melting-point glass paste to a substrate having electrodes formed thereon using the die coater of claim 1 to form a coat layer; and firing the coat layer to form a dielectric layer.
